(19) United States
(12) Patent Application Publication
(10) Pub. No.: US 2018/0141854 A1
(43) Pub. Date: May 24, 2018

(54) METHOD OF FABRICATING AN ANTI-GLARE, STRENGTHENED, ANTI-MICROBIAL AND ANTIFINGERPRINT STRENGTHENED GLASS

(71) Applicant: Hony Glass Technology Co., Ltd., NEW TAIPEI CITY (TW)

(72) Inventor: Wen-Liang Huang, New Taipei City (TW)

(21) Appl. No.: 15/814,367

(22) Filed: Nov. 15, 2017

(30) Foreign Application Priority Data
Nov. 18, 2016 (TW) 105137739

(51) Int. Cl. C03C 15/00; C03C 17/00; C03C 17/06; C03C 17/23; C03C 21/00

(52) U.S. Cl. CPC C03C 15/00; C03C 17/008; C03C 17/06; C03C 17/23; C03C 2217/73; C03C 2203/50; C03C 2217/228; C03C 2217/256; C03C 2217/285; C03C 21/005

(57) ABSTRACT

The present invention provides a method of manufacturing a glass with anti-glare, strengthened, anti-microbial and anti-fingerprint capabilities. A glass substrate is provided with a target surface. Plural treatments are carried out, including: performing an anti-glare treatment upon the target surface by using a mixed acid solution; performing a strengthening treatment by using KNO₃; performing an anti-microbial treatment by using a silver-containing fluid; and performing an anti-fingerprint treatment by forming a fluorocarbon siloxane layer on the target surface.

### BACKGROUND OF THE INVENTION

### 1. Field of the Invention

The present invention relates generally to a method of fabricating a multi-functional glass. In particular, the present invention is directed to a method of fabricating a glass with anti-glare, strengthened, anti-microbial and anti-fingerprint capabilities.

### 2. Description of the Prior Art

Mobile communication devices with the touch panel application are currently used throughout the world so everyone has a smart phone. In order to improve the outdoor usability of smart phones, the anti-glare and anti-reflective coating treatments are performed on the panel. In addition to smart phones, the touch panel is also commonly used for ATMs, vending machines and portable tablet PCs, and is also widely used for large-scale interactive touch screens of public facilities such as electronic touch interactive guide cards.

The touch panel is used for smart phones and portable tablet PCs, and is commonly used for public facilities including ATMs, vending machines and electronic touch interactive guide cards. After many times of use and many finger contacts, the touch panel will accumulate invisible bacteria and visible fingerprints and filth, the follow-up users run the risk of contamination and infection. Therefore, the touch panel needs to perform the anti-microbial treatment and anti-fingerprint treatment.

The panel of mobile phones and part of the flat-panel displays uses touch-type. The operation of mobile phones and the function and display of the flat-panel displays are carried out through a finger pressing or touching the panel. After many people, many times, and long-term use of the touch panel, there is a need of the tempered glass with resistant-pressing. Because many people using the touch panel will leave the vague fingerprints, resulting in poor panel visual effects. With the problem brought by fingerprints, fingerprint oil ester contains contamination, bacteria, mold and virus, causing infection transmission.

In recent years, the amount of touch panels is increasing and the functional requirements of touch panels is expanding, therefore, there is a need of a new multi-functional glass and the production technology, which can make the glass have anti-glare, strengthened, anti-bacterial and anti-fingerprint effects.

For example, Carlson et al. already has a patent issued as TWI 496751 on 21 Aug. 2015, wherein a glass etching containing Al₂O₃ is performed by using hydrofluoric acid (HF) solution to obtain surface roughened glass, and then a chemical strengthening is performed by using surface Na/K ion exchange to produce an strengthened anti-glare glass. However, the glass of TWI 496751 does not have anti-bacterial and anti-fingerprint effects.

The United States Guardian company, Wang et al., already has a patent issued as U.S. Pat. No. 8,968,831 B2 on 3 Mar. 2015, in which the micron roughening is performed on the glass surface, and then splashing water or a hydrophilic material coating are applied, thereby forming a glass with anti-glare and anti-fingerprint coated glass. However, the glass of U.S. Pat. No. 8,968,831 B2 does not have anti-bacterial and strengthened effects.

### SUMMARY OF THE INVENTION

The present invention provides a glass with anti-glare, strengthened, anti-microbial and anti-fingerprint capabilities.

According to a main embodiment of the present invention, there is provided a method of manufacturing a glass with anti-glare, strengthened, anti-microbial and anti-fingerprint capability. First, a glass substrate with a target surface is provided. Then, the following steps are performed: performing an anti-glare treatment upon the target surface by using a mixed acid solution; performing a strengthening treatment upon the target surface by using KNO₃; performing an anti-microbial treatment upon the target surface by using a silver-containing fluid; and performing an anti-fingerprint treatment upon the target surface by forming a fluorocarbon siloxane layer on the target surface.

The method of manufacturing a glass with multi-functions provided by the present invention has proved that it makes the multi-functional glass have good anti-glare, strengthened, anti-microbial and anti-fingerprint capabilities.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of manufacturing a glass with anti-glare, strengthened, anti-microbial and anti-fingerprint capabilities according to the present invention;

FIGS. 2 to 7 illustrate a schematic view of a method of manufacturing a glass with anti-glare, strengthened, anti-microbial and anti-fingerprint capabilities according to the present invention;

FIGS. 8 and 9 are microscopic photographs of a glass with anti-glare, strengthened, anti-microbial and anti-fingerprint capabilities according to the present invention.

### DETAILED DESCRIPTION

To provide a better understanding of the presented invention to persons having skill in the art, preferred embodiments are described in detail following. The preferred embodiments of the present invention are illustrated in the accompanying drawings with numbered elements and the desired effects are achieved.

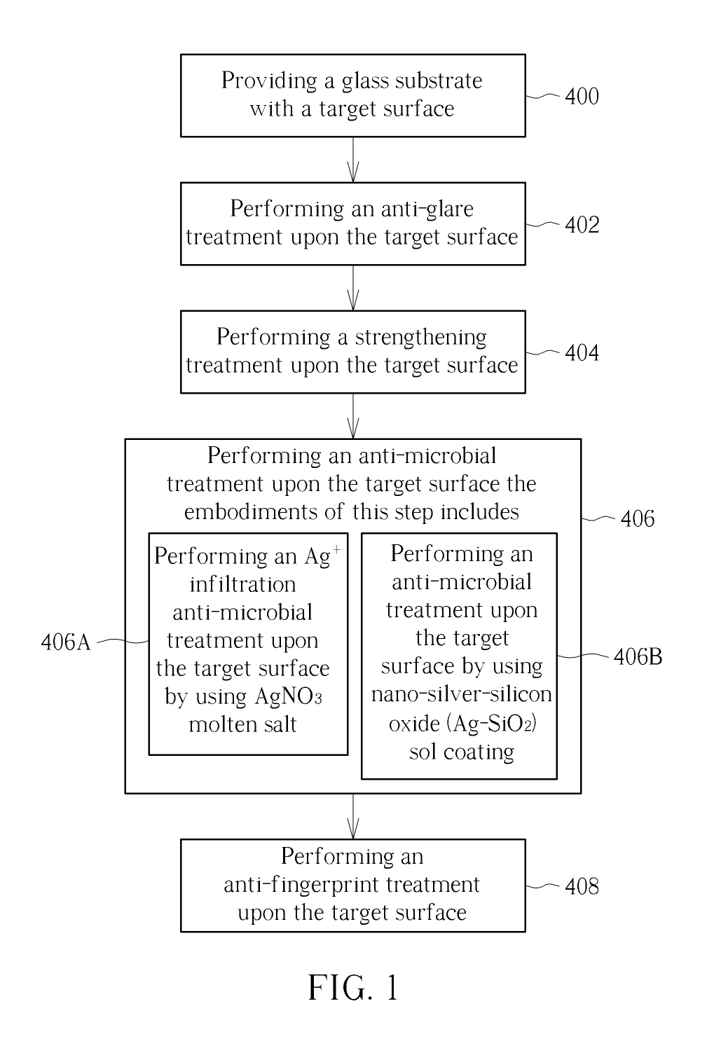

The present invention provides a glass with anti-glare, strengthened, anti-microbial and anti-fingerprint capabilities. FIG. 1 is a flow chart of manufacturing a glass with anti-glare, strengthened, anti-microbial and anti-fingerprint capabilities according to the present invention. As shown in FIG. 1, the method of manufacturing a glass including following steps:

Step 400: providing a glass substrate with a target surface;

Step 402: performing an anti-glare treatment upon the target surface;

Step 404: performing a strengthening treatment upon the target surface;

Step 406: performing an anti-microbial treatment upon the target surface; the embodiments of this step includes:

Step 406A: performing an Ag⁺ infiltration anti-microbial treatment upon the target surface by using AgNO₃ molten salt;

Step 406B: performing an anti-microbial treatment upon the target surface by using nano-silver-silicon oxide (Ag—SiO₂) sol coating;

Step 408: performing an anti-fingerprint treatment upon the target surface.

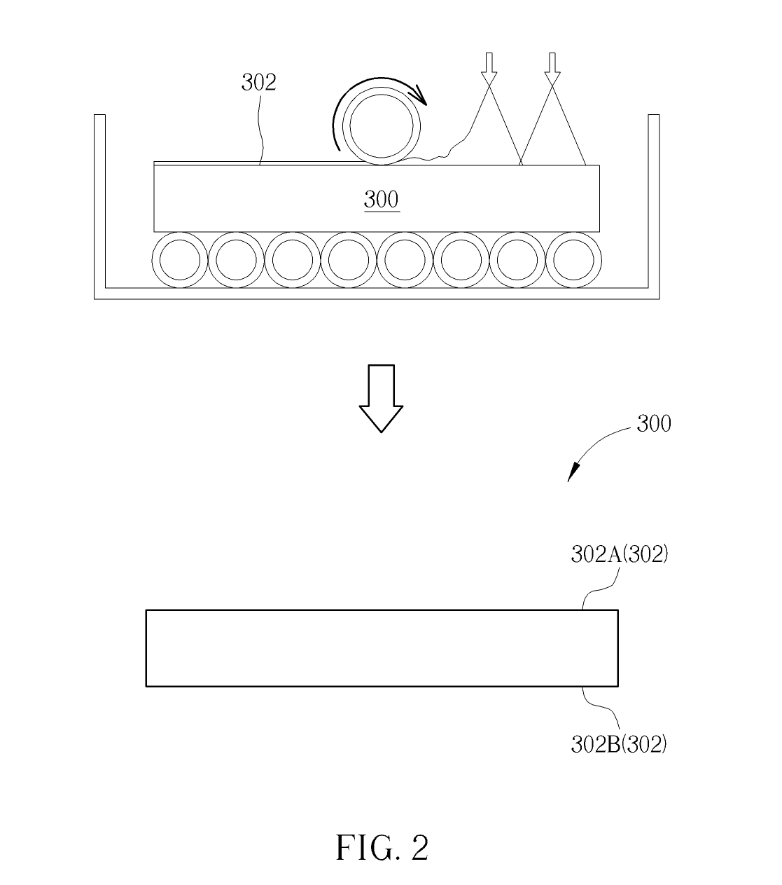

For the purpose of describing in detail the manufacturing steps of the present invention; please refer to FIGS. 2 to 7, which illustrate a schematic view of a method of manufacturing a glass with anti-glare, strengthened, anti-microbial and anti-fingerprint capabilities according to the present invention. First, as shown in FIG. 2, a glass substrate 300 is provided, and the glass is cleaned and decontaminated (step 400) so that it has at least one target surface 302 available for use. The target surface 302 may be on any side of the glass substrate 300 or the glass substrate 300 has a plurality of target surfaces 302, such as two opposing target surfaces 302A, 302B arranged in parallel, so that the both sides of the glass substrate 300 may be processed simultaneously and get the required effect.

In one embodiment, the glass substrate 300 is flat glass having a thickness of 0.5 to 6.0 millimeter (mm), and its main content is soda-lime glass or aluminum silicate glass, and may contain silicon oxide (SiO₂), sodium oxide (Na₂O), potassium oxide (K₂O), Lithium oxide (Li₂O), magnesium oxide (MgO), calcium oxide (CaO), boron oxide (B₂O₃), alumina (Al₂O₃), arsenic oxide (As₂O₃), zirconium oxide (ZrO₂), titanium oxide (TiO₂), tin oxide (SnO₂), or cerium oxide (CeO₂); preferable is silicon oxide (SiO₂), sodium oxide (Na₂O), boron oxide (B₂O₃), or alumina (Al₂O₃), but are not limited thereto.

In one embodiment, the glass substrate 300 contains a silicon oxide (SiO₂) content of 66 mole %, an alumina (Al₂O₃) content of 10 mole %, a sodium oxide (Na₂O) content of 14 mole %, a potassium oxide (K₂O) content of 2.5 mole %, a magnesium oxide (MgO) content of 5.7 mole %, a calcium oxide (CaO) content of 0.6 mole %, a boron oxide (B₂O₃) content of 0.6 mole %.

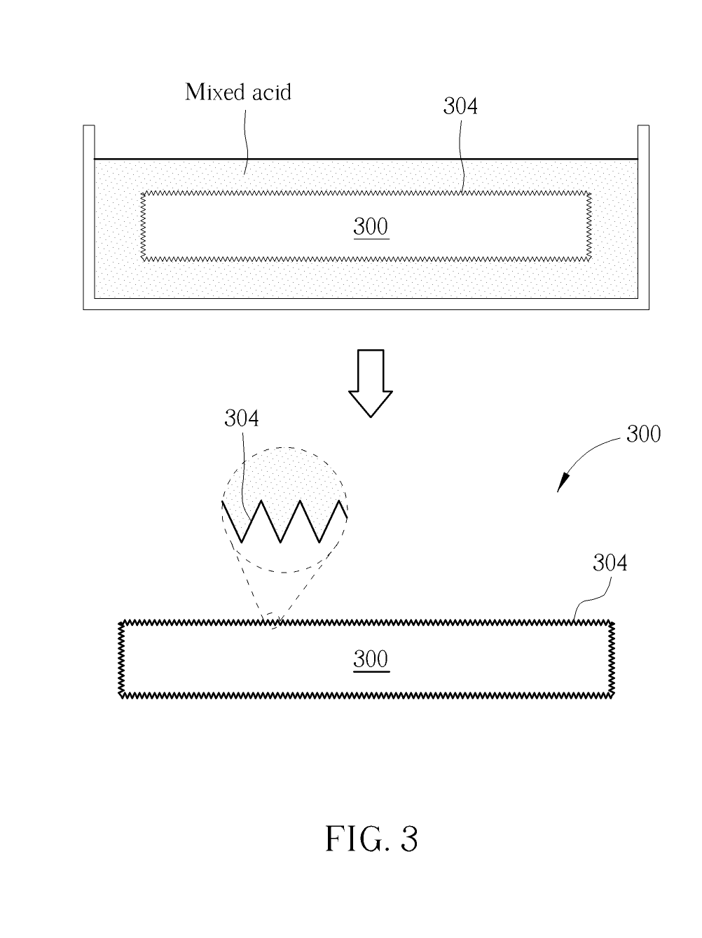

Next, as shown in FIG. 3, an anti-glare treatment (step 402) is performed upon the target surface 302 of the glass substrate 300 so that the target surface 304 has anti-glare ability. In an embodiment of the present invention, the anti-glare treatment (step 402) includes the use of a mixed acid solution to produce a nonporous gradient film on the target surface 302 by etching, thereby forming a nano awl-shaped roughened surface, wherein the outer layer of the gradient film is sparse and the inner layer of the gradient film is dense. In one embodiment, the main contents of the mixed acid solution may include hydrofluoric acid (HF), sulfuric acid (H₂SO₄), hydrochloric acid (hydrochloric acid, HCl), acetic acid (CH₃COOH), ammonium fluoride (NH₄F), sodium fluoride (NaF), potassium fluoride (KF), ammonium sulfate ((NH₄)₂SO₄), potassium sulfate (K₂SO₄), potassium bifluoride (KHF₂), sodium bifluoride (NaHF₂) or ammonium bifluoride (NH₄HF₂), but are not limited thereto. In one embodiment, the mixed acid solution may not include hydrofluoric acid (HF), making the process preparation and use safer. Moreover, a fluorine surfactant may optionally be added into the formulation of the mixed acid solution, preferably at a concentration of 50 to 400 ppm, for example, 100 ppm, allowing the surface 302 of the glass substrate 300 to be cleaned. The anti-glare surface 304 is obtained through acid etching and has good quality so that the process is easy to control. In one embodiment, the mixed acid solution includes ammonium bifluoride (NH₄HF₂) (6 to 10 wt %)+propylene glycol (10 to 20%) solution+water (84 to 70%)+fluorocarbon surfactant (>100 ppm). In another embodiment, the mixed acid solution includes ammonium bifluoride (NH₄HF₂) (6-10%)+sodium bifluoride (NaHF₂) (2%)+propylene glycol (10 to 20%) solution+water (84 to 70%)+Fluorocarbon surfactant (>100 ppm). In an embodiment of the present invention, the anti-glare treatment 304 includes the following steps: (1) etching with HF acid for 5 minutes; (2) rinsing with deionized water (DI water) for 1 minute; (3) soaking with H₂SO₄ (1M) for 5 minutes; (4) rinsing with DI water for 1 minute; (5) soaking with HF (4 wt %)+HCl (4 wt %) aqueous solution for 10 minutes; (6) rinsing with DI water for 1 minute; and (7) drying with nitrogen (N₂).

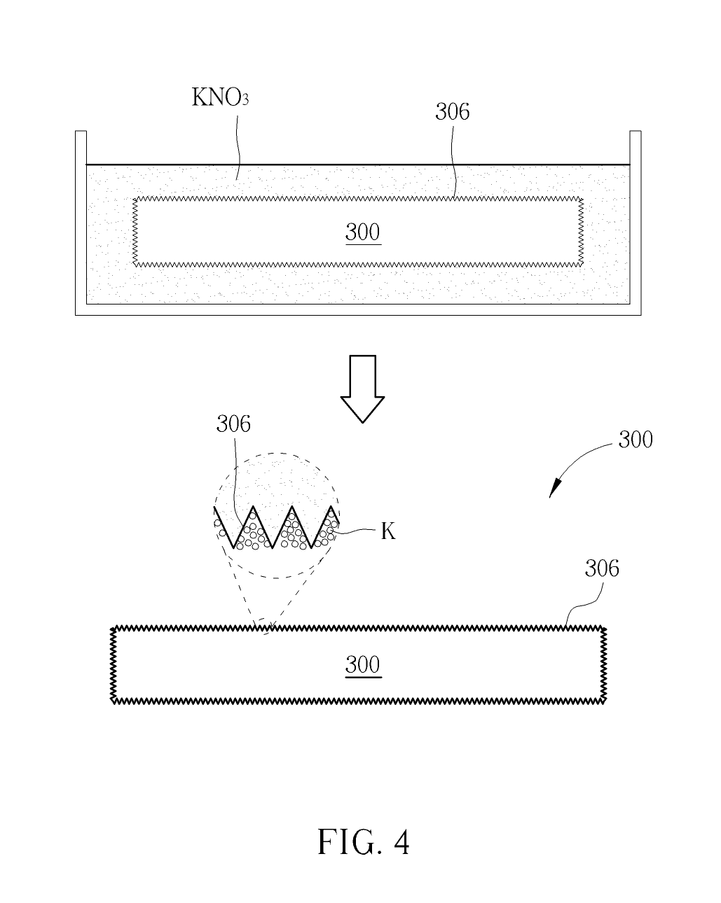

Next, as shown in FIG. 4, a strengthening treatment (step 404) is performed upon the resulting anti-glare glass surface 304 to obtain a strengthened anti-glare surface 306, thereby making the anti-glare glass surface 304 have a strengthened effect. The strengthening treatment (step 404) is, for example, a chemical enhancement process. The chemical enhancement process includes the use of potassium nitrite (KNO₃). In one embodiment, the target surface 304 is immersed in the KNO₃ at a temperature of 400 to 450° C. for 3 to 6 hours to perform the exchange of sodium ions on the target surface 304 with potassium ions in the KNO₃.

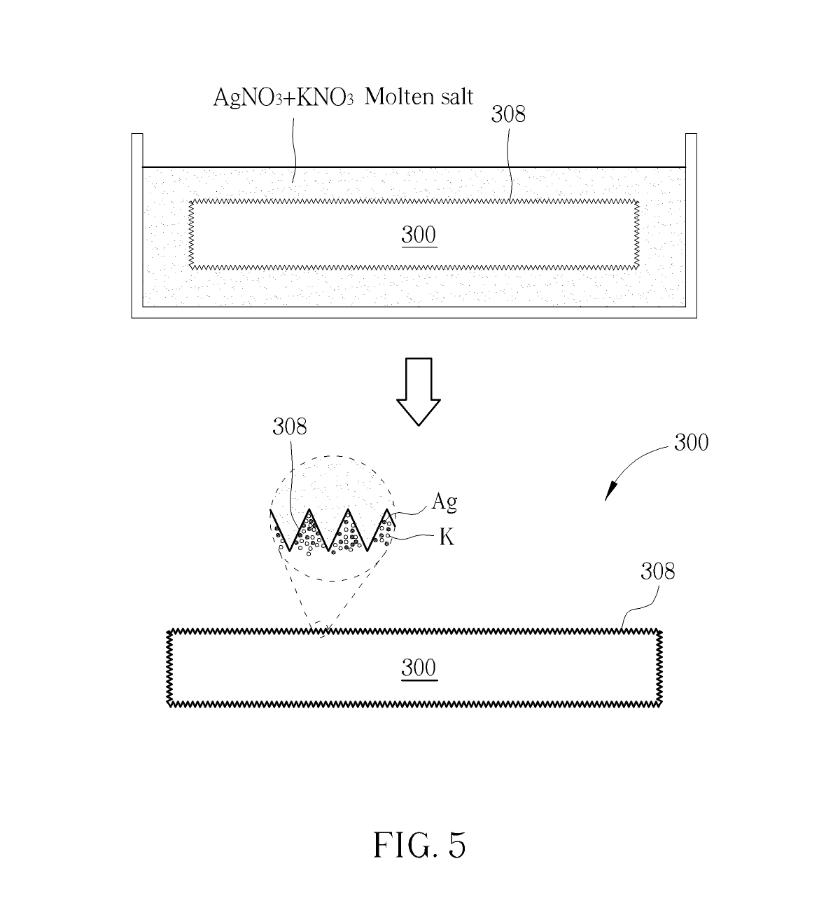

Next, as shown in FIG. 5, an anti-microbial treatment (step 406A) is performed upon the resulting strengthened anti-glare glass surface 306 to make the target surface 308 have anti-microbial capability. The anti-microbial treatment of the present invention is performed by using a silver-containing substance. In an embodiment, the silver-containing substance is, for example, a mixed molten salt of AgNO₃ and KNO₃. In this embodiment, the anti-microbial treatment is performed by immersing the strengthened anti-glare glass surface 306 into the mixed molten salt of AgNO₃ and KNO₃ for 10 to 30 minutes, wherein AgNO₃/KNO₃≤0.25 wt % and the process temperature is about 400 to 450° C., to perform thermal diffusion and exchange between the strengthened anti-glare glass surface 306 and the silver ions in the AgNO₃—KNO₃ molten salt, thereby making the surface layer of the strengthened anti-glare glass contain nano-silver, therefore, the target surface 308 has anti-microbial capability.

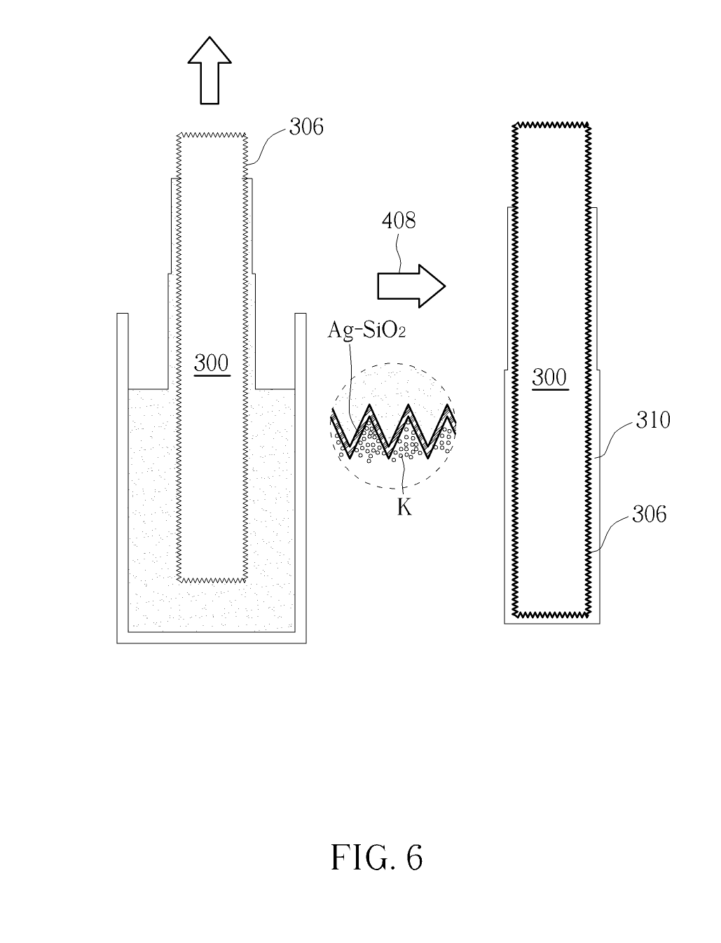

In another embodiment, the resulting strengthened anti-glare glass surface 306 is optionally coated with a nano-silver-silicon oxide (Ag—SiO₂) sol. As shown in FIG. 6, the anti-microbial treatment of this example (step 406B) is performed on the strengthened anti-glare glass surface 306 with a nano-silver-silicon oxide (Ag—SiO₂) sol coating to form an anti-reflective and anti-microbial coating surface 310, wherein the thickness of the coating is about ¼λ, λ=550 nanometer (nm). In one embodiment, the silver-silicon oxide (Ag—SiO₂) sol is prepared by mixing an amine siloxane chelating agent with an AgNO₃ solution followed by the addition of a SiO₂ sol, followed by the addition of a reducing agent such as formaldehyde. The above SiO₂ sol contains: SiO₂-MOₓ inorganic mixed sol, or SiO₂-epoxy siloxane mixed sol.

In another embodiment, an anti-microbial treatment (step 406A) of molten salt silver ion Ag⁺ diffusion is performed on the resulting strengthened anti-glare glass surface 306, followed by an anti-microbial treatment (step 406B) of Ag—SiO₂ sol coating. The above two anti-microbial treatment examples are combined, for example, by performing a treatment with the mixed molten salt of AgNO₃ and KNO₃ to obtain a nano silver permeated anti-microbial surface 308, and then performing a treatment with the nano-silver-silicon oxide (Ag—SiO₂) sol coating, thereby forming an anti-reflective and anti-microbial coating surface 310.

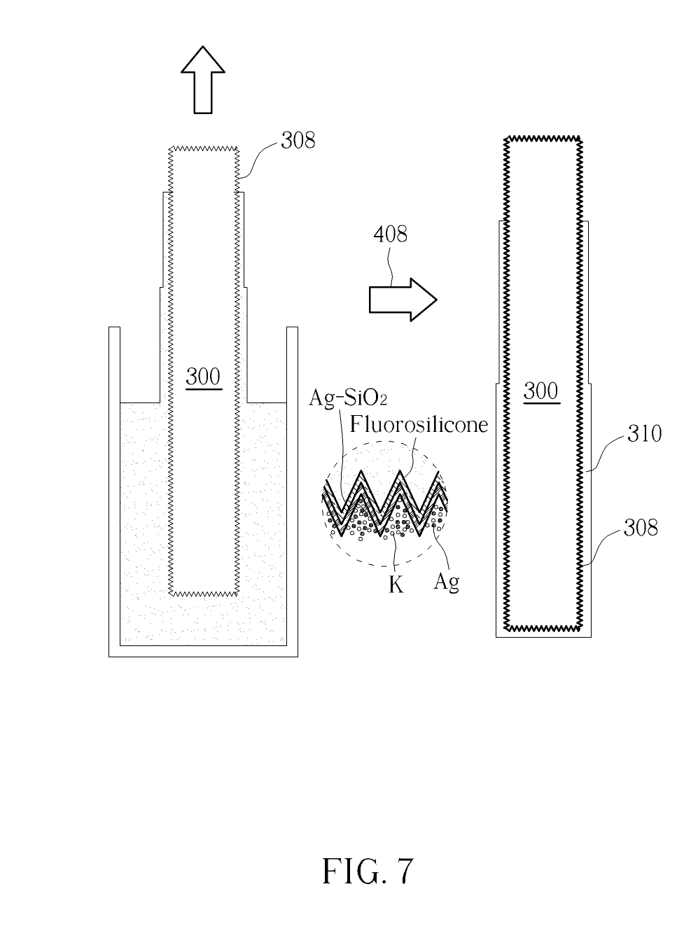

Next, as shown in FIG. 7, the resulting glass with anti-glare, strengthened, and anti-microbial capability or with anti-glare, strengthened, and anti-reflective is optionally subject to an anti-fingerprint treatment 312 (step 408). In one embodiment, an anti-fingerprint treatment 312 is performed by using a fluorocarbon siloxane sol to form an anti-fingerprint film (314) on the target surface 308 or 310. The raw material of the fluorocarbon siloxane sol is fluorocarbon ether siloxane (RO)₃—Si—(CH₂)₃—[O(CF₂)₂]ₙ—F or fluorosilicone (RO)₃—Si—(CH₂)₃—(C₂F₄)ₙ—F, wherein 4≤n≤10, and then performing hydrolysis and gluing by dissolving the raw material.

The anti-glare treatment, strengthening treatment, anti-microbial treatment and anti-fingerprint treatment may be performed upon the flat glass through the above steps. It should be noted that the aforementioned treatment techniques such as the anti-glare treatment 402, the strengthening treatment 404, the anti-microbial treatment 406A or 406B and anti-fingerprint treatment 408, the resulting multi-functional panel glass has different effects due to performing different anti-microbial treatments 406A or 406B. A glass with anti-reflective capability is obtained by forming an anti-microbial coating surface 310 by using nano-silver-silicon oxide (Ag—SiO₂) sol, which can enhance the anti-glare effect. Then, the anti-fingerprint treatment is performed to obtain a multi-functional panel glass having the best effect.

During the anti-microbial treatment, the exchange of silver ions by using the molten salt of AgNO₃ and KNO₃ to obtain an anti-microbial surface 308 can be optionally performed, or an anti-microbial coating surface 310 can be optionally formed by using nano-silver-silicon oxide (Ag—SiO₂) sol. A glass with a better anti-glare effect is obtained by forming the anti-microbial coating surface 310 by using nano-silver-silicon oxide (Ag—SiO₂) sol, followed by performing an anti-fingerprint treatment to form an anti-fingerprint coating 312.

In the embodiments of the present invention, the lower cost processing steps are in the following order: anti-glare treatment 302, strengthening treatment 304, anti-microbial treatment 306, and anti-fingerprint treatment 312.

Hereinafter, embodiments and experiments of the present invention will be described to confirm the anti-glare, strengthened, anti-microbial and anti-fingerprint capability of glass substrates.

### Example 1

A method of manufacturing a glass with anti-glare capability.

An anti-glare glass of example 1 is manufactured by performing a glass etched anti-glare roughening process with HF mixed acid. The formulation of HF mixed acid of the present invention has two characteristics: (1) if the concentration of any ingredient used in the formulation is 0, the ingredient may not be used. Therefore, hydrofluoric acid (HF) may not be used in the formulations 1 to 4 to make the process preparation and use safer; (2) a fluorine surfactant in a concentration of 100 ppm is added into the formulation of the HF mixed acid to manufacture an anti-glare rough surface layer having good quality and easy to control by performing a glass etching process. The formulations of HF mixed acid used in the present invention are listed in Table 1.

TABLE 1
formulation of HF mixed acid

| | formulation | | | | | |
|---|---|---|---|---|---|---|
| ingredient | 1 | 2 | 3 | 4 | 5 | 6 |
| Hydrofluoric acid (49 wt %)% | | 0~5 | 0~5 | 0~5 | 3~5 | 4~6 |
| sulfuric acid (98 wt %)% | 15~35 | 10~20 | 10~15 | 0~5 | | |
| hydrochloric acid (35 wt %)% | | 0~10 | 0~10 | 15~20 | | |
| acetic acid % | 5~20 | 5~15 | 5~10 | 0~5 | | |
| ammonium fluoride (40%)% | 10~35 | 5~15 | 0~10 | 0~5 | 3-5 | 3-5 |
| sodium fluoride % | | 0~5 | 5~10 | 0~5 | | 1 |
| potassium fluoride % | | 0~5 | 0~5 | 0~5 | | |
| ammonium sulfate % | | 0~5 | 0~5 | 0~5 | | |
| potassium sulfate % | | | 0~5 | 10~15 | | |
| potassium bifluoride % | | 0~5 | 0~5 | 20~15 | | |
| water % | 5~70 | 10~80 | 15~80 | 10~55 | 70~84 | 68~82 |
| fluorine surfactant ppm | 100 | 100 | 100 | 100 | 100 | 100 |
| propylene glycol % | 0~5 | 0~5 | 0~5 | 0~5 | 10~20 | 10~20 |

An anti-glare glass having preferable quality is manufactured by performing an anti-glare glass etching process with the formulation 1 of HF mixed acid, wherein the formulation 1 includes sulfuric acid (98 wt %) 15-40%, acetic acid 5-20%, ammonium fluoride (40%) 10-40%, water 5-80% and fluorine surfactant 100˜400 ppm.

A method of manufacturing a glass with anti-glare and chemical strengthened capability.

A chemical strengthening treatment is performed by immersing a glass in the KNO₃ as a raw material at a temperature of 400 to 450° C. for 3 to 6 hours to manufacture a glass with anti-glare, strengthened capabilities.

First, in order to confirm the effect of the strengthening treatment of the present invention, please refer to Table 2 and Table 3. Table 2 and Table 3 are the measurements of the production temperature, time test and glass strength of, respectively, two kinds of glass substrates: soda-lime glass and aluminum silicate glass, after immersing in the KNO₃. The results are expressed in terms of two parameters: Compressed Strength (CS) and Depth of Layer (DoL). The unit of Compressed Strength (CS) is Mpa and the unit of Depth of Layer (DoL) is microns (μm).

In the case of soda-lime glass, the general untreated soda-lime glass has strength of about 100 MPa. As shown in Table 2, after the chemical strengthening treatment with KNO₃, the soda-lime glass has a Compressed Strength >400 MPa, Depth of Layer >8 μm, confirmed that the chemical strengthening treatment of the present invention can effectively strengthen the soda-lime glass. Preferably, performing the chemical strengthening treatment at a temperature ≥425° C. for ≥3 hours can get better chemical effect of the soda-lime glass. In the case of aluminum silicate glass, the general untreated aluminum silicate glass has strength of about 100 MPa. As shown in Table 3, after the chemical strengthening treatment with KNO₃, the aluminum silicate glass has a Compressed Strength >800 MPa, Depth of Layer >40 μm, confirmed that the chemical strengthening treatment of the present invention can effectively strengthen the aluminum silicate glass. Preferably, performing the chemical strengthening treatment at a temperature ≥425° C. for ≥3 hours can get better chemical effect of the aluminum silicate glass.

TABLE 2
strength of soda-lime glass

| | temperature | | | | | |
|---|---|---|---|---|---|---|
| | 400° C. | | 425° C. | | 450° C. | |
| | Compressed | Depth of | Compressed | Depth of | Compressed | Depth of |
| | Strength | Layer | Strength | Layer | Strength | Layer |
| time | (Mpa) | (DoL) | (Mpa) | (DoL) | (Mpa) | (DoL) |
| 1 Hr | 550 ± 50 | 4 ± 2 | 700 ± 50 | 6 ± 2 | 650 ± 50 | 8 ± 2 |
| 2 Hr | 500 ± 50 | 6 ± 2 | 700 ± 50 | 8 ± 2 | 650 ± 50 | 12 ± 2 |
| 3 Hr | 450 ± 50 | 8 ± 2 | 600 ± 50 | 10 ± 2 | 500 ± 50 | 14 ± 2 |
| 4 Hr | 450 ± 50 | 9 ± 2 | 650 ± 50 | 12 ± 2 | 500 ± 50 | 17 ± 2 |

TABLE 3
strength of aluminum silicate glass

| | temperature | | | | | |
|---|---|---|---|---|---|---|
| | 400° C. | | 425° C. | | 450° C. | |
| | Compressed | Depth of | Compressed | Depth of | Compressed | Depth of |
| | Strength | Layer | Strength | Layer | Strength | Layer |
| time | (Mpa) | (DoL) | (Mpa) | (DoL) | (Mpa) | (DoL) |
| 1 Hr | 750 ± 50 | 14 ± 2 | 900 ± 50 | 20 ± 2 | 900 ± 50 | 26 ± 2 |
| 2 Hr | 700 ± 50 | 20 ± 2 | 900 ± 50 | 27 ± 2 | 850 ± 50 | 35 ± 2 |
| 3 Hr | 700 ± 50 | 25 ± 2 | 900 ± 50 | 33 ± 2 | 850 ± 50 | 43 ± 2 |
| 4 Hr | 700 ± 50 | 28 ± 2 | 900 ± 50 | 37 ± 2 | 850 ± 50 | 50 ± 2 |

A method of manufacturing a glass with anti-glare, strengthened and nano silver anti-microbial capability.

An anti-glare strengthened glass is immersed in the mixed molten salt of AgNO₃ and KNO₃ for 10-30 minutes to exchange silver ions, thereby forming a nano-silver anti-glare strengthened glass, wherein the AgNO₃/KNO₃ is used in an amount of 0.01-5.0 wt % and the process temperature is 350-425° C. An anti-microbial rate if the resulting glass with nano-silver anti-microbial, anti-glare and strengthened capabilities is 99.9%.

Optical and surface anti-glare quality measurement results of nano-silver anti-glare strengthened glass productions are shown in Table 4. The sample 1 and the sample 2 refer to two different components of the glass to perform sample manufacture and sample test. In the measured items, GLOSS is measured by BYK-4374 produced by BYK; reflectivity (% R) is measured by spectrophotometer (MCPD-3000) produced by Otsuka; transmittance (% T) and haze are measured by the NDH-5000 haze machine produced by Nippon Denshoku Industries Co. LTD; the image discrimination is measured by IQ-206085 produced by Rhopoint Co; the rough Ra, RPc, Rz and Rmax are measured by the SJ-1 produced by Mitutoyo Co., Ltd.

TABLE 4
anti-glare measurement of nano-silver anti-
microbial anti-glare strengthened glass

| measured | measured | | |
|---|---|---|---|
| instrument | items | sample 1 | sample 2 |
| BYK-4374 | GLOSS(GU) | 86.2~96.8 | 107~115 |
| MCPD-3000 | % R | 6.01% | 6.19% |
| NDH-5000 haze | % T | 91.8% | 92.15% |
| machine | HAZE(%) | 2.79% | 2.31% |
| Rhopoint, IQ-206085 | DOI(%) | 71.9~77.1 | 94.9~96.4 |
| ROUGHNESS | Ra (μm) | 0.16 | 0.107 |
| SJ-410 | RPc(cm) | 327.87 | 408.16 |
| Roughness meter | Rz (μm) | 1.00 | 0.51 |

A method of manufacturing a glass with anti-glare, strengthened, nano silver anti-microbial and anti-fingerprint capabilities.

Nano-silver anti-microbial anti-glare strengthened glass coating is performed by using fluorocarbon ether siloxane (RO)₃—Si—(CH₂)₃—[O(CF₂)₂]ₙ—F or fluorosilicone (RO)₃—Si—(CH₂)₃—(C₂F₄)ₙ—F as a raw material dissolved in ethanol (EtOH) solvent to obtain fluorosilicone solution in the concentration of 0.01 to 1.0 wt %, thereby manufacturing a glass with anti-glare, strengthened, anti-microbial and anti-fingerprint capabilities. The contact angle and wear resistance of the glass are measured to Measure the anti-microbial changes. The results are list in Table 5. If anti-microbial anti-glare strengthened glass coating is performed by using fluorocarbon ether siloxane (RO)₃—Si—(CH₂)₃—[O(CF₂)₂]ₙ—F dissolved in ethanol (EtOH) solvent in the concentration of 0.01 wt %, the water contact angle of the glass may be greater than 100° to make the glass have anti-fingerprint capability. The use of the concentration of 0.05 wt %, water contact angle of the glass may be greater than 110°; the use of concentration of 0.5 wt %, water contact angle of the glass is up to 118°. The anti-microbial capability of the glass is not reduced by fluorosilicone coating.

TABLE 5
measurement of water contact angle and anti-microbial capability
of anti-glare anti-microbial anti-fingerprint strengthened glass

| anti-glare anti-microbial | | | | | |
|---|---|---|---|---|---|
| anti-fingerprint | | | | | |
| strengthened glass | | water contact angle | | anti-microbial rate | |
| Fluorocarbon | | Before | After | Before | After |
| compounds | concentration | coating | coating | coating | coating |
| fluorocarbon | 0.01 wt % | 20° | 101° | 99.9% | 99.9% |
| ether | 0.02 wt % | 20° | 107° | 99.9% | 99.9% |
| siloxane | 0.05 wt % | 20° | 110° | 99.9% | 99.9% |
| | 0.10 wt % | 20° | 115° | 99.9% | 99.9% |
| | 0.20 wt % | 20° | 115° | 99.9% | 99.9% |
| | 0.50 wt % | 20° | 118° | 99.9% | 99.9% |
| | 1.00 wt % | 20° | 118° | 99.9% | 99.9% |
| fluoro- | 0.01 wt % | 20° | 98° | 99.9% | 99.9% |
| silicone | 0.02 wt % | 20° | 102° | 99.9% | 99.9% |
| | 0.05 wt % | 20° | 105° | 99.9% | 99.9% |
| | 0.10 wt % | 20° | 105° | 99.9% | 99.9% |
| | 0.20 wt % | 20° | 108° | 99.9% | 99.9% |
| | 0.50 wt % | 20° | 108° | 99.9% | 99.9% |
| | 1.00 wt % | 20° | 110° | 99.9% | 99.9% |

### Example 2

High efficiency anti-glare anti-microbial anti-fingerprint strengthened glass production.

A glass etched roughening process is performed by using HF mixed acid to manufacture an anti-glare glass. The quality of the anti-glare glass is shown in Table 1 and the anti-glare effects of anti-glare glass are shown in Table 2. The anti-glare glass of the present example is manufactured by using formula 1 of HF mixed acid.

A chemical strengthening treatment is performed by immersing the glass in the KNO₃ at a temperature of 400 to 450° C. for 3 to 5 hours to manufacture a glass with anti-glare, strengthened capabilities.

First, nano-silver-silicon oxide (Ag—SiO₂) sol is prepared. Next, an anti-glare strengthened glass optical coating is performed to manufacture a high efficiency anti-glare anti-microbial glass, wherein the thickness of the coating is ¼λ, λ=550 nm. The formulations of the Ag—SiO₂ sol are listed in Table 6. SiO₂ mixed sol is produced by using nano-silver-silicon oxide sol with different formulations for hydrolysis condensation. A nano-silver anti-microbial coating is performed upon the anti-glare glass. The main components of the formulations are AgNO₃, formaldehyde, amine siloxane chelating agent such as KBM-903 (3-aminopropyltriethoxysilane [(C₂H₅O)₃SiC₃H₆NH₂] supplied by Shin-Etsu Co., Ltd., KBM-603 (N-2 aminoethyl-3-aminopropyltrimethoxysilane [(CH₃O)₃SiC₃H₆NHC₂H₄NH₂] with a tetraoxysilane. In order to manufacture a high efficiency anti-glare anti-microbial glass, the sol of formulation 2 is used to improve anti-glare effect, wherein the coating refractive index is ≤1.46.

TABLE 6
formulations of the Ag—SiO₂ sol

| Ag—SiO₂ sol | | Formulation 1 | Formulation 2 | Formulation 3 |
|---|---|---|---|---|
| AgNO₃ (mole) | | 0.1~1.0 | 0.1~1.0 | 0.1~1.0 |
| formaldehyde (mole) | | 0.2~2.0 | 0.2~2.0 | 0.2~2.0 |
| amine siloxane | KBM-903(mole) | | | 0.5~5.0 |
| chelating agent | KBM-603(mole) | 0.5~5.0 | 0.5~5.0 | |
| SiO₂ sol | SiO2—TiO₂ sol (1:1) | 10 mole | | |
| | SiO₂ sol | | 10 mole | 10 mole |

A high efficiency anti-glare anti-microbial glass is manufactured by performing an anti-glare strengthened glass sol coating using the sol with formulation 2. The coating quality of the glass are measured and shown in Table 7. The anti-glare effects of the glass are great, wherein average reflectivity R is <5.0% invisible light, transmittance T is >87%, scattering rate A is >11%. The pencil hardness of the glass is up to 8H grade, CNS 13033 of the glass is A-level and CNS 13033 is B-level.

TABLE 7
quality measurement of high efficiency anti-
glare anti-microbial strengthened glass

| measured | measured | measured | | back- | |
|---|---|---|---|---|---|
| items | instruments | ranges | results | ground | value |
| % R | MCPD-300 | 380~780 nm | 4.82% | 550 nm | 3.54% |
| % T | HITACHI | 300~380 nm | 46.99% | | |
| | | 380~780 nm | 87.82% | 550 nm | 88.27% |
| A % | 1-R %-T % | 380~780 nm | 9.03% | 550 nm | 9.32% |
| pencil | ASTM | 765 g | 8H | | |
| hardness | D3363-92A | | | | |
| Acid and | Acid 6Hr | After | 90% | Before | 89.74% |
| alkali | | immersing | | immersing | |
| resistance | Acid 24Hr | After | 89.19% | Before | 89.21% |
| NDH- | | immersing | | immersing | |
| 5000 | CNS 13033 | level | A-level | | |
| | alkali 6Hr | After | 87.42% | Before | 89.19% |
| | | immersing | | immersing | |
| | alkali 24Hr | After | 75.60% | Before | 88.04% |
| | | immersing | | immersing | |
| | CNS 13033 | level | B-level | | |

Next, a high efficiency anti-glare anti-microbial anti-fingerprint strengthened glass is manufactured by performing a nano-silver anti-glare strengthened glass coating with fluorosilicone solution. The anti-glare effects of the glass are great and are shown in Table 8, for example, an average reflectance R=5.44% in visible light, transmittance T=92.75%, DOI=89.1%. The microscope shows transmitted image and reflection image.

TABLE 8
anti-glare effect of high efficiency anti-glare anti-
microbial anti-fingerprint strengthened glass

| measured | measured | |
|---|---|---|
| instruments | items | G/EAG/AB/AF |
| BYK-4374 | GLOSS (GU) | 96.7~102 |
| MCPD - 3000 | % R | 5.44% |
| NDH-5000 | % T | 92.75% |
| RHOPOINT | DOI (%) | 89.1% |
| IQ-206085 | | |
| Roughness meter | Ra (μm) | 0.163 |
| SJ-410 | RPC/cm | 268.46 |
| | RZ (μm) | 1.099 |
| CAM-100 | Water droplets angle | 110° |
| Digital scale | Etching depth (μm) | 151~166 |

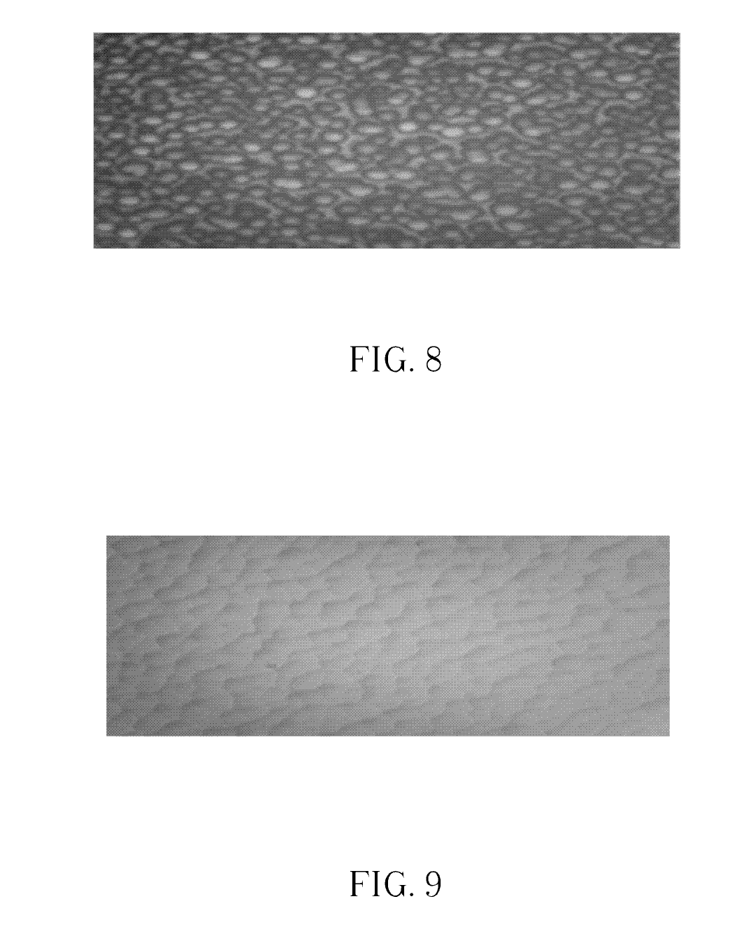

FIGS. 8 and 9 are microscopic photographs, taken by a FINDER XMB-100B microscope, of a glass with anti-glare, strengthened, anti-microbial and anti-fingerprint capabilities according to the present invention. FIG. 8 is a transmitted image and FIG. 9 is a reflection image.

In view of the above, the present invention provides a method of manufacturing a glass with anti-glare, strengthened, anti-microbial and anti-fingerprint capabilities. The glass of the present invention may be applied to any electronic product, for example on a display device, preferably on a touch display device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of manufacturing a glass with anti-glare, strengthened, anti-microbial and anti-fingerprint capabilities, comprising:
providing a glass substrate with a target surface;
performing an anti-glare treatment upon the target surface by using a mixed acid solution;
performing a strengthening treatment by using KNO₃;
performing an anti-microbial treatment by using a silver-containing fluid; and
performing an anti-fingerprint treatment by forming a fluorocarbon siloxane layer on the target surface.

2. The method of manufacturing a glass with anti-glare, strengthened, anti-microbial and anti-fingerprint capabilities according to claim 1, wherein the mixed acid solution in the anti-glare treatment does not comprise hydrofluoric acid (HF) until the use of mixed reaction to produce hydrofluoric acid.

3. The method of manufacturing a glass with anti-glare, strengthened, anti-microbial and anti-fingerprint capabilities according to claim 2, wherein the anti-glare treatment comprises using a fluorine surfactant.

4. The method of manufacturing a glass with anti-glare, strengthened, anti-microbial and anti-fingerprint capabilities according to claim 3, wherein a concentration of the fluorine surfactant is from 50 to 400 parts per million (ppm).

5. The method of manufacturing a glass with anti-glare, strengthened, anti-microbial and anti-fingerprint capabilities according to claim 1, wherein the anti-glare treatment is performed before the strengthening treatment.

6. The method of manufacturing a glass with anti-glare, strengthened, anti-microbial and anti-fingerprint capabilities according to claim 1, wherein the silver-containing fluid in the anti-microbial treatment comprises silver nitrate (AgNO₃)/potassium nitrate (KNO₃) molten salt.

7. The method of manufacturing a glass with anti-glare, strengthened, anti-microbial and anti-fingerprint capabilities according to claim 6, wherein a glass substrate silver ion exchange is performed by using the silver nitrate (AgNO₃)/potassium nitrate (KNO₃) molten salt in the anti-microbial treatment, wherein a concentration of the silver nitrate/potassium nitrate (AgNO₃/KNO₃) molten salt is ≥0.01% by weight.

8. The method of manufacturing a glass with anti-glare, strengthened, anti-microbial and anti-fingerprint capabilities according to claim 1, wherein the silver-containing fluid in the anti-microbial treatment comprises using a nano-silver-silicon oxide (Ag—SiO₂) sol to form an anti-microbial coating on the target surface.

9. The method of manufacturing a glass with anti-glare, strengthened, anti-microbial and anti-fingerprint capabilities according to claim 8, wherein the nano-silver-silicon oxide (Ag—SiO₂) sol comprises silver nitrate (AgNO₃), formaldehyde, amine siloxane chelating agent and silicon dioxide (SiO₂).

10. The method of manufacturing a glass with anti-glare, strengthened, anti-microbial and anti-fingerprint capabilities according to claim 1, wherein the anti-glare treatment is performed, and then the strengthening treatment is performed, followed by the anti-microbial treatment, and then the anti-fingerprint treatment.
